(19) United States
(12) Patent Application Publication
(10) Pub. No.: US 2012/0071177 A1
(43) Pub. Date: Mar. 22, 2012

(54) Method of Discontinuous Reception and Wireless Communication Device in Wireless Communication System

(76) Inventors: Kuo-Hao Hung, Taipei Hsien (TW); Cheng-Ying Hsieh, Taipei Hsien (TW); Chwu-Wuang Hsieh, Taipei Hsien (TW)

(21) Appl. No.: 12/953,462

(22) Filed: Nov. 24, 2010

(30) Foreign Application Priority Data
Sep. 21, 2010 (TW) 099132043

(51) Int. Cl. H04W 68/00

(52) U.S. Cl. 455/458

(57) ABSTRACT

A method of discontinuous reception (DRX) for a user equipment in a wireless communication system includes triggering a DRX function, prolonging a DRX cycle indicated by a network terminal of the wireless communication system with a predetermined multiple, and monitoring at least one paging message outputted from the network terminal according to the prolonged DRX cycle.

### BACKGROUND OF THE INVENTION

1. Field of the Invention

The present invention relates to a method of discontinuous reception (DRX) and wireless communication device in a wireless communication system, and more particularly, to a method capable of reducing triggering times of a reception circuit of the wireless communication device after a DRX function is started, so as to effectively reduce power consumption.

2. Description of the Prior Art

The third generation (3G) mobile communication technology adopts a Wideband Code Division Multiple Access (WCDMA) wireless air interface access method for a cellular network. WCDMA can provide high frequency spectrum utilization, universal coverage and high quality, high speed multimedia data transmission. The WCDMA method also fulfills all kinds of QoS requirements simultaneously, providing diverse flexible two-way transmission services and better communication quality, to reduce transmission interruption rates.

In a universal mobile telecommunication system (UMTS), the 3G mobile communication system is composed of a user equipment (UE), a UMTS terrestrial radio access network (UTRAN) and a core network (CN). The UE connects with a base station (Node-B) of the UTRAN, exchanges information with a radio network controller (RNC) of the UTRAN, and interfaces with a telecommunication service network, such as PSTN, ISDN, Internet, etc., via a circuit-switched system and a packet-switched system in the CN, to perform all kinds of voice and data transmission services. A 3G protocol stack can be segmented into access stratum (AS) and non-access stratum (NAS), wherein the AS includes a radio resource control (RRC), radio link control (RLC), medium access control (MAC), packet data convergence protocol (PDCP), broadcast/multicast control (BMC), and other sub-layers of different functions. The RRC is the third layer protocol as well as a core of the AS, for performing radio resource message exchange, radio resource configuration, QoS control, channel transmission format configuration, packet segmentation reconstruction and NAS communication protocol processing.

The RRC layer defines various RRC states to describe the usage of radio resource for the UE. RRC states can be divided into idle mode and RRC connected mode according to whether the RRC connection is established. The idle mode includes an IDLE (Idle) state, while the RRC connected mode is further divided into a CELL_PCH (Cell Forward Access Channel) state, a URA_PCH (UMTS Radio Access Network Registration Area Paging Channel) state, a CELL_FACH (Cell Forward Access Channel) state and a CELL DCH (Cell Dedicated Channel) state. In the CELL DCH state, the UE and the network terminal exchange data via a dedicated channel, and when the transmission amount is lower than a configuration of the network terminal for a predefined period, the UE enters the CELL_FACH state. In the CELL_FACH state, the UE and the network terminal exchange data via a common channel, and when the transmission amount exceeds the configuration of the network terminal, the UE enters the CELL_FACH state. In the CELL_PCH state, the UE monitors a paging channel and enters the CELL_FACH state if there is data to be transmitted or received. In the URA_PCH state, the UE operates as in the CELL_PCH state; the difference is during mobility, the CELL_PCH state updates location information for the network terminal according to differences in every Node-B serving cell, while the URA_PCH state gathers several serving cells as groups and updates the location information for the network terminal when the groups are different.

As the 3G mobile communication system develops, mobile communication products, such as mobile phones, laptops with build-in data cards, even smart phones, etc., are equipped with far more complex circuits than past products. In such a situation, in order to provide mobile multimedia services with continuous and high transmission rate, power consumption is a very rigorous challenge in wireless communication systems. Therefore, a discontinuous reception (DRX) function is provided for reducing power consumption of the UE in the IDLE, CELL_PCH and URA_PCH states. The DRX function allows an idle wireless communication product to turnoff radio receiver for a while (called DRX cycle), hence significantly reducing power consumption.

The DRX function can reduce power consumption of wireless communication products; however, for present portable wireless communication products stressing on light and compact designs, improvement is needed. Therefore, how to further reduce power consumption of portable wireless communication devices becomes one of the goals in the industry.

### SUMMARY OF THE INVENTION

Therefore, the present invention mainly provides discontinuous reception (DRX) method and wireless communication device in wireless communication system.

The present invention discloses a DRX method for a user equipment of a wireless communication system. The method comprises steps of triggering a DRX function, prolonging a the DRX cycle indicated by a network terminal of the wireless communication system with a predetermined multiple, and monitoring at least one paging message outputted from the network terminal according to the prolonged DRX cycle.

The present invention further discloses a wireless communication device for performing DRX in a wireless communication system. The communication device comprises a CPU, for executing a program, and a memory, coupled to the CPU, for storing the program. The program is utilized for indicating the CPU to execute steps of triggering a DRX function, prolonging a DRX cycle indicated by a network terminal of the wireless communication system with a predetermined multiple, and monitoring at least one paging message outputted from the network terminal according to the prolonged DRX cycle.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a wireless communication system.

FIG. 2 illustrates a functional block diagram of a wireless communication device.

FIG. 3 illustrates a schematic diagram of a program shown in FIG. 2.

FIG. 4 illustrates a schematic diagram of a process according to an embodiment of the present invention.

FIG. 5 illustrates a schematic diagram of a 2-time discontinuous reception cycle according to an embodiment of the present invention.

### DETAILED DESCRIPTION

The present invention aims at wireless communication devices supporting only packet-switched (PS) operations, i.e. not supporting circuit-switched (CS) operations, such as data cards, data modules, modems, to prolong discontinuous reception (DRX) cycle a multiple times in the idle mode, so as to reduce operating time of a reception circuit, and reduce power consumption as well.

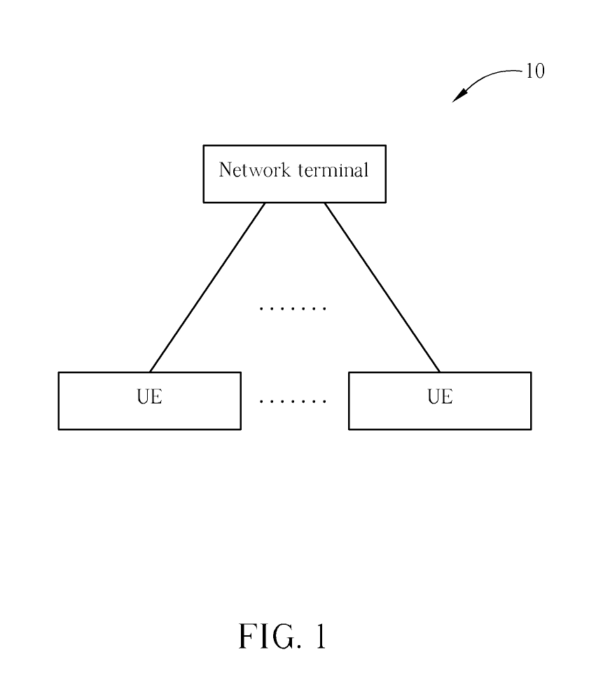

In detail, please refer to FIG. 1, which illustrates a schematic diagram of a wireless communication system 10. The wireless communication system 10 is preferably a 3G mobile communication system, roughly composed of a network terminal and a plurality of user equipments (UEs). In FIG. 1, the network terminal and the UEs are simply utilized for illustrating the structure of the wireless communication system 10. In practice, the network terminal may comprise a plurality of base stations (Node Bs), radio network controllers and so on according to actual demands, and the UEs can be mobile phones, computer systems, etc.

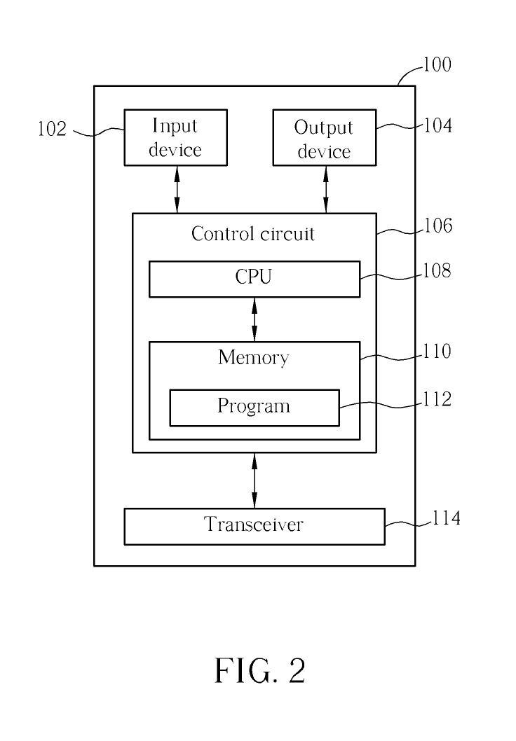

Please refer to FIG. 2, which illustrates a functional block diagram of a wireless communication device 100. The wireless communication device 100 can be used for implementing the UEs shown in FIG. 1, and only supports PS operations but does not support CS operations. For the sake of brevity, FIG. 2 merely shows an input device 102, an output device 104, a control circuit 106, a central processing unit (CPU) 108, a memory 110, a program 112 and a transceiver 114 of the wireless communication device 100. In the wireless communication device 100, the control circuit 106 executes the program 112 stored in the memory 110 through the CPU 108, so as to control operations of the wireless communication device 100. The wireless communication device 100 can receive signals input by a user through the input device 102, such as a keyboard, and can output images and sounds through the output device 104, such as a monitor, speakers, etc. The transceiver 114 is utilized to receive or transmit wireless signals, deliver the received signals to the control circuit 106, and output signals generated by the control circuit 106 wirelessly. In other words, from a perspective of a communication protocol framework, the transceiver 114 can be seen as a portion of Layer 1, and the control circuit 106 can be utilized for realizing Layer 2 and Layer 3.

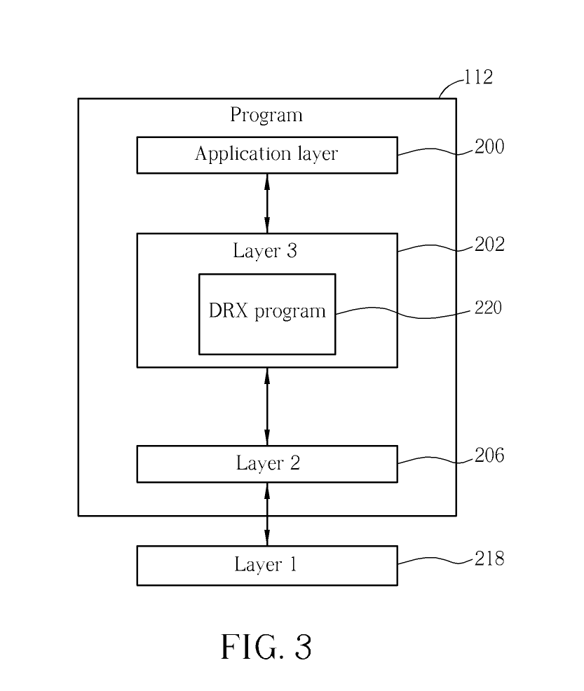

Please continue to refer to FIG. 3, which illustrates a schematic diagram of the program 112 shown in FIG. 2. The program 112 includes an application Layer 200, a Layer 3 202 and a Layer 2 206, and is coupled to a Layer 1 218. The Layer 3 202 performs radio resource control (RRC). The Layer 2 206 comprises a radio link control (RLC) layer and a medium access control (MAC) layer, and performs link control. The Layer 1 218 performs physical connections.

In the 3G mobile communication system, the Layer 3 202 supports a DRX function, allowing the UE to discontinuously receiving messages from the network terminal when operating in the IDLE, CELL_PCH or URA_PCH state, so as to reduce power consumption. In such a situation, in order to enhance power saving effect of the DRX function, the present invention provides a DRX program 220 in the program 112, in order to reduce power consumption of the idle UE.

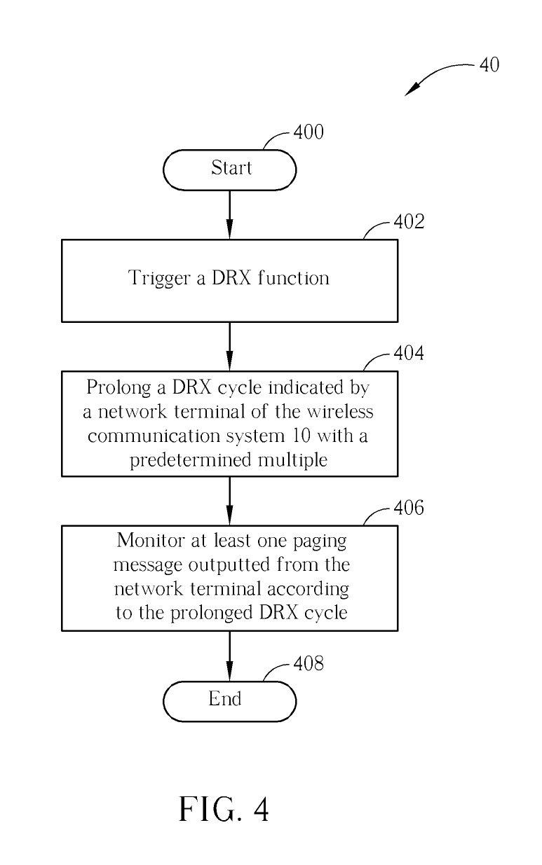

Please refer to FIG. 4, which illustrates a schematic diagram of a process 40 according to an embodiment of the present invention. The process 40 is utilized for the UEs in the wireless communication system 10, and can be compiled into the DRX program 220. As shown in FIG. 4, the process 40 includes following steps:

Steps 400: Start.

Steps 402: Trigger a DRX function.

Steps 404: Prolong a DRX cycle indicated by a network terminal of the wireless communication system 10 with a predetermined multiple.

Steps 406: Monitor at least one paging message outputted from the network terminal according to the prolonged DRX cycle.

Steps 408: End.

According to the process 40, after the UE triggers the DRX function, the UE prolongs the DRX cycle indicated by the network terminal with the predetermined multiple, and monitors the paging channel according to the prolonged DRX cycle, to receive the paging message from the network terminal. In short, after the DRX function is triggered, the present invention prolongs the DRX cycle indicated by the network terminal with the predetermined multiple. Consequently, a frequency of the UE being “waked up” can be reduced, so as to reduce power consumption.

In detail, when the UE operates in the CELL_FACH state or the CELL DCH state, if there is no transmission request for a period, the UE enters the IDLE, CELL_PCH or URA_PCH state, and triggers the DRX function. In such a situation, according to the process 40, the UE prolongs the DRX cycle to multiple times, to reduce time and frequency of triggering a reception circuit, so as to reduce power consumption. Note that, the present invention mainly aims at UEs supporting only PS operations, but not supporting CS operations; therefore, there is no real-time voice service requirement, and thus prolonging the DRX cycle affects very little on service quality.

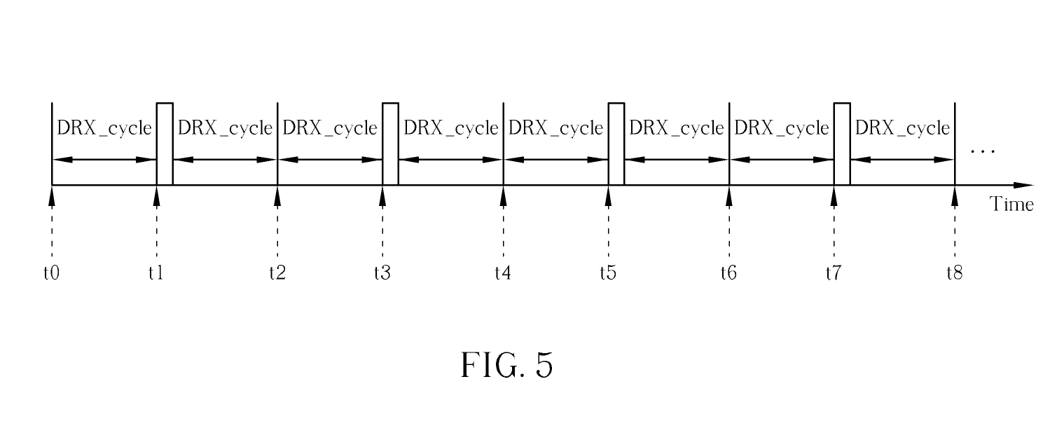

In addition, in the process 40, the UE prolongs the DRX cycle with an integer multiple. The integer multiple can be configured according to system requirements. For example, please refer to FIG. 5, which illustrates a schematic diagram of a 2-time DRX cycle according to an embodiment of the present invention. In FIG. 5, rectangle blocks represent the UE triggering the reception circuit to operate, and DRX_cycle represents the DRX cycle indicated by the network terminal. As can be seen from FIG. 5, the UE triggers the DRX function at time to, and then triggers the reception circuit at time t1, t3, t5 and so forth. In such a situation, after the DRX function is triggered, since the UE triggers the reception circuit once per 2-time DRX cycle, the number of triggering the reception circuit is only half of the prior art. As a result, power consumption can be effectively reduced, which is beneficial for the wireless communication products stressing on compact designs.

FIG. 5 takes the 2-time DRX cycle as example. However, note that, not limited to 2 times, other integers can also be applied to the present invention. Meanwhile, adaptive mechanism can be added, e.g. hierarchical adjustment. Namely, after the UE triggers the DRX function, the UE monitors the paging channel with the original DRX cycle for a predetermined period of time, and step by step, changes to other multiples of DRX cycle, such as 2-time, 3-time DRX cycle, etc.

To sum up, aiming at wireless communication devices supporting only PS operations, the present invention prolongs the DRX cycle with the integer multiple, to reduce the number of triggering the reception circuit after the DRX function is triggered, so as to effectively reducing power consumption.

Those skilled in the art will readily observe that numerous modifications and alterations of the device and method may be made while retaining the teachings of the invention.

What is claimed is:

1. A discontinuous reception (DRX) method for a user equipment of a wireless communication system, the method comprising:
triggering a DRX function;
prolonging a DRX cycle indicated by a network terminal of the wireless communication system with a predetermined multiple; and
monitoring at least one paging message outputted from the network terminal according to the prolonged DRX cycle.

2. The DRX method of claim 1, wherein the user equipment operates in an IDLE state, CELL_FACH (Cell Forward Access Channel) state or URA_PCH (Universal Mobile Telecommunications System Terrestrial Radio Access Network Registration Area Paging Channel) state.

3. The DRX method of claim 1, wherein the predetermined multiple is an integer.

4. The DRX method of claim 1, wherein the wireless communication system is a third generation mobile communication system.

5. A wireless communication device for performing discontinuous reception (DRX) in a wireless communication system, the communication device comprising:
a CPU, for executing a program; and
a memory, coupled to the CPU, for storing the program; wherein the program is utilized for indicating the CPU to execute following steps:
triggering a DRX function;
prolonging a DRX cycle indicated by a network terminal of the wireless communication system with a predetermined multiple; and
monitoring at least one paging message outputted from the network terminal according to the prolonged DRX cycle.

6. The wireless communication device of claim 5 operating in an IDLE state, CELL_FACH (Cell Forward Access Channel) state or URA_PCH (Universal Mobile Telecommunications System Terrestrial Radio Access Network Registration Area Paging Channel) state.

7. The wireless communication device of claim 5, wherein the predetermined multiple is an integer.

8. The wireless communication device of claim 5, wherein the wireless communication system is a third generation mobile communication system.
